(19) United States
(12) Patent Application Publication
(10) Pub. No.: US 2019/0072522 A1
(43) Pub. Date: Mar. 7, 2019

(54) System and Method for Detecting and Characterizing Defects in a Pipe

(71) Applicant: Desjardins Integrity Ltd., Calgary (CA)

(72) Inventor: Guy Joseph Daniel DESJARDINS, Calgary (CA)

(21) Appl. No.: 16/182,228

(22) Filed: Nov. 6, 2018

Related U.S. Application Data
(63) Continuation of application No. PCT/CA2017/050579, filed on May 15, 2017.
(60) Provisional application No. 62/339,423, filed on May 20, 2016.

(51) Int. Cl. G01N 27/87

(52) U.S. Cl. CPC G01N 27/87

(57) ABSTRACT

An in-line inspection device and methods of operation thereof for identifying and characterizing features of a metallic pipe structure are disclosed. An in-line inspection device with a central body supports an instrument apparatus which includes a plurality of magnetic members to magnetically saturate the pipe, and a plurality of magnetic sensor assemblies to detect magnetic flux leakage signals caused by pipe features. The plurality of magnetic sensor assemblies are positioned such that some are as close as practicable to the internal surface of the pipe, and others are at a predetermined offset distance from the internal surface of the pipe. By analyzing and comparing the outputs of the magnetic sensor assemblies, pipeline features can be identified and characterized.

### CROSS-REFERENCE TO RELATED APPLICATION(S)

This application is a continuation of PCT Application No. PCT/CA2017/050579 filed on May 15, 2017, which claims priority to U.S. Provisional Patent Application No. 62/339,423 filed on May 20, 2016, both incorporated herein by reference.

### TECHNICAL FIELD

The following relates to systems and methods for detecting and/or characterizing defects in pipes and other tubular members, including pipelines.

### DESCRIPTION OF THE RELATED ART

Pipelines are often used to transport petroleum products, natural gas, hazardous liquids, and the like. Once installed, a pipeline is found to inevitably corrode or otherwise develop defects. Such defects include metal loss, dents, cracks, and other mechanical damage.

Magnetic flux leakage inspection devices, commonly referring to as “pigs”, are tools that are propelled along a pipeline by the pressure of a fluid in the pipeline, for various servicing purposes. The use of magnetic flux leakage inspection devices in pipelines is an established technology. Typically, by using a plurality of magnets, a magnetic field may be created which substantially magnetically saturates a portion of the circumferential length of the pipe through which the device moves. Sensors can then identify and measure the magnetic flux leakage caused by defects, and this information can further be recorded to provide inspection data.

Some in-line inspection devices include primary sensor assemblies to identify defects that occur in a ferromagnetic pipeline, both on the internal surface and on the external surface of the pipeline. Modern magnetic flux leakage measuring technologies typically rely on Hall-effect sensors for this purpose. However, the current conventional configuration of magnetic sensors may be unable to discriminate between which defects occur on the internal pipeline surface and which ones occur on the external surface.

Consequently, other in-line inspection devices have been developed to include secondary sensor assemblies, which may be of a different type than the primary sensors, to discriminate between inner-diameter (ID) which occur on the internal surface of a pipeline, and outer-diameter (OD) defects which occur on the external surface of a pipeline. The secondary sensors are typically eddy current sensors. Eddy currents may be induced by the instrument and the signals can be detected by the sensors. Due to the limited range of eddy currents, the eddy current sensor systems reveal only internal defects. Used in conjunction with the information collected by the primary sensor systems, internal and external defects can be distinguished. However, typical eddy current sensing systems can consume significant amounts of power and reduce battery life. Further, such secondary sensor assemblies need additional space and storage, which leads to a higher cost associated with materials, constructing the device, and employing the device inside a pipeline.

It is an object of the following to provide a system and method that addresses the aforementioned concerns.

### SUMMARY

The in-line inspection device described herein is used to identify and characterize the features of a metallic pipe structure through which it passes. The device moves within a pipeline in the direction of a fluid flow, and is enabled to move through the pipeline via a plurality of annular cups supported by the device body which trap the fluid and engage the internal pipeline wall.

In an implementation, the in-line inspection device supports an instrument apparatus. The instrument apparatus includes a plurality of magnetic assemblies for providing a magnetic field to magnetically saturate the length of pipe through which the in-line inspection device passes. Also supported by the instrument apparatus is a plurality of near-wall magnetic sensor assemblies positioned as close as practicable to the internal pipeline wall, and a plurality of offset magnetic sensor assemblies positioned at an offset distance from the internal pipeline wall, wherein both near-wall and offset magnetic sensor assemblies may detect magnetic flux leakage signals caused by pipeline features. Due to their positions relative to the internal pipeline wall, the near-wall magnetic sensor assemblies may detect a different range of magnetic flux leakage signals than the offset magnetic sensor assemblies. By combining the data collected by the near-wall and offset magnetic assemblies, additional details about pipeline features can be determined than what may be determined with only near-wall magnetic sensor assemblies. These additional details may include, but are not limited to: shape, size, radial position, and clock position of the features, wherein the radial position refers to the internal/external nature of a feature, and the clock position refers to the circumferential position of a feature.

Various implementations may also further provide a method for characterizing the features of a metallic pipe structure, comprising: generating a magnetic field using the magnetic assemblies, instructing the magnetic sensor assemblies to continuously perform measurements to detect magnetic flux leakage signals that may be caused by a pipeline feature, processing each signal in a processing circuit, storing the processed information in a recorder, and utilizing the information to determine desired characteristics about pipeline features.

### BRIEF DESCRIPTION OF THE DRAWINGS

Embodiments will now be described by way of example only with reference to the appended drawings wherein:

FIG. 1 is an elevational view of one embodiment of an in-line inspection device.

FIG. 2 is an enlarged view of the instrumentation apparatus of the in-line inspection device depicted in FIG. 1.

FIG. 3 is a perspective cross-sectional view of the instrumentation apparatus depicted in FIG. 2.

FIG. 4 is a diagrammatic view of a portion of the instrumentation apparatus depicted in FIG. 2, including a schematic illustration of functional processing blocks for operating the inspection device.

FIG. 5 is an enlarged view, as viewed in a circumferential direction, of a pipeline wall and a section of the instrumentation apparatus which contains a plurality of magnetic sensor assemblies.

FIG. 6 is a schematic diagram, as viewed in an axial direction, which illustrates the spatial relationships between a plurality of magnetic sensor assemblies supported by a section of the instrumentation apparatus of the inspection device, and an internal feature along a pipeline surface.

FIG. 7 is a schematic diagram, as viewed in an axial direction, which illustrates the spatial relationships between a plurality of magnetic sensor assemblies supported by a section of the instrumentation apparatus of the inspection device, and an external feature along a pipeline surface.

FIG. 8 is a graph which shows the magnetic amplitudes obtained by a near-wall sensor and offset sensor for an internal feature.

FIG. 9 is a graph which shows the magnetic amplitudes obtained by a near-wall sensor and offset sensor for an external feature.

FIG. 10 is a flow chart which illustrates a set of operations that can be performed in inspecting a pipeline for defects.

### DETAILED DESCRIPTION

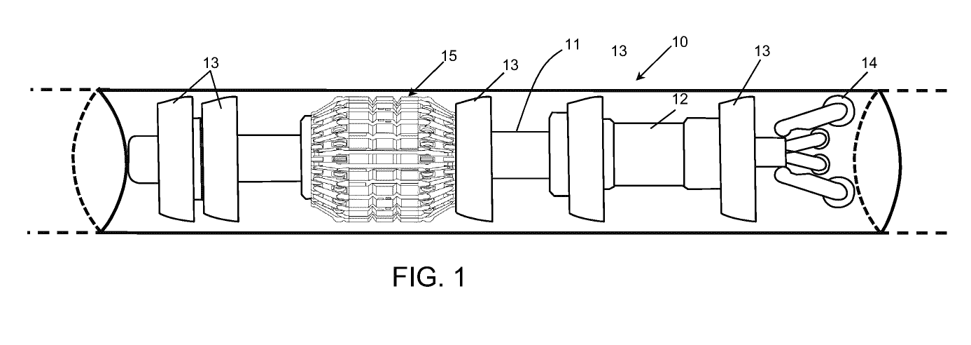

Referring to FIG. 1, an in-line inspection device 10 used for various pipeline servicing purposes is shown. The in-line inspection device 10 in this example includes a plurality of annular cups 13 affixed around the circumference of the central body 11 which serve to center the inspection device 10 within the pipeline and also to engage the internal pipeline wall so as to trap the flowing fluid, enabling the device to be pushed along the pipeline by the fluid. In the embodiment shown, the in-line inspection device 10 has an instrumentation apparatus 15 that supports magnetic sensor assemblies as discussed below, and a support module 12 that may house the batteries and other electronic and/or recording equipment. Further, the tail end of the device 10 may comprise one or more odometers 14 which measure the distance travelled by the device 10 and provide signals that reveal the location of a pipeline feature.

The inspection device 10 shown is illustrated by way of example only and not by limitation. That is, other inspection device sizes and configurations are possible. Depending on the configuration of the in-line inspection device 10 and the size of the pipeline to be inspected, the arrangement and number of components may also vary.

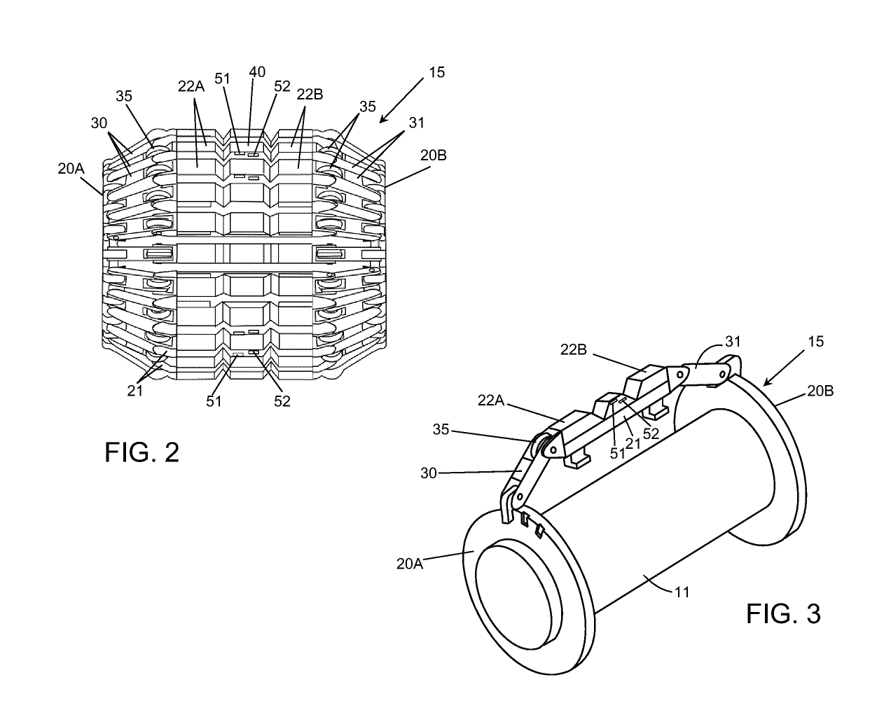

The instrumentation apparatus 15 is shown in greater detail in FIGS. 2-5. Referring to FIG. 2, the instrumentation apparatus 15 includes end plates 20A and 20B, and is supported by or otherwise attached to the central body 11. Between the end plates 20A, 20B is a plurality of armatures 21 aligned parallel with respect to each other and arranged circumferentially around the central body 11. Magnets of opposing polarities 22A and 22B are affixed to either end of each armature 21. The magnets 22A and 22B generate a magnetic field such that the length of pipe between them is substantially continuously magnetically saturated as the inspection device 10 moves through the pipeline.

Referring to FIG. 3, the ends of each armature 21 are connected to a forward arm 30 and rearward arm 31. The other end of each forward arm 30 is attached to the end plate 20A. Similarly, the other end of each rearward arm 31 is attached to the end plate 20B. The forward and rearward arms 30 and 31 link the plurality of armatures 21 to the central body 11 and allow variance in the radial position of each armature 21 such that the instrumentation apparatus 15 can tailor to any variances in the interior dimensions of the pipe wall through which the inspection device 10 moves. In order to keep the magnets 22A and 22B from being damaged (e.g., due to contact with the interior of the pipeline wall), spacers 35 are employed in order to ensure that the magnets 22A and 22B are in close proximity to, but not in physical contact with, the interior of the pipeline wall.

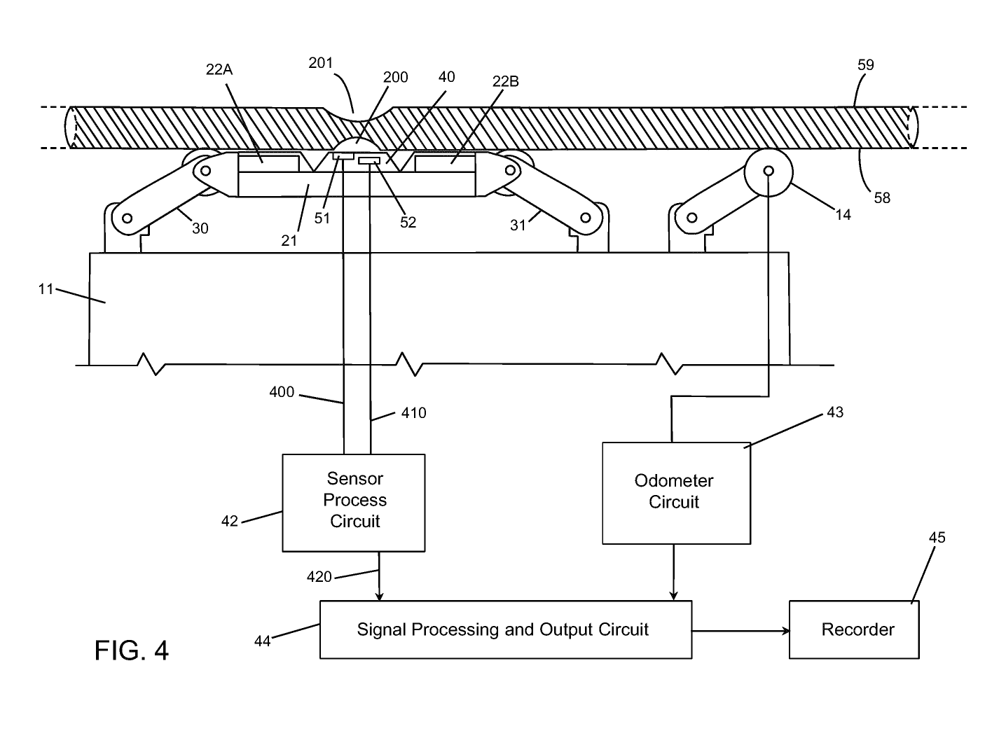

Referring to FIG. 4, a portion of the instrumentation apparatus 15 is shown, which provides further detail for one of the armatures 21, the magnets of opposing polarities 22A and 22B, forward and rearward arms 30 and 31 which link the armature 21 to the central body 11 of the inspection device 10, and a head assembly 40 between the magnets 22A, 22B, which contains a plurality of magnetic sensor assemblies 51 and 52. The head assembly 40 contains at least one near-wall magnetic sensor assembly 51 positioned as close as practicable to the internal pipeline wall 58, and at least one offset magnetic sensor assembly 52 positioned at a predetermined offset distance from the internal wall 58. The at least one near-wall magnetic sensor assembly 51 and the at least one offset magnetic sensor assembly 52 collect magnetic flux leakage signals as the in-line inspection device 10 moves through the pipeline. Due to the difference in position with respect to the pipeline wall, an offset magnetic sensor assembly 52 may capture signals of a different range and magnitude than a near-wall magnetic sensor assembly 51 located in the same head assembly 40. The data obtained by the sensor assemblies 51 and 52 for a particular feature may then be compared to determine various characteristics of the feature. For example, the ratio of the amplitudes of the magnetic signals acquired by the two types of sensor assemblies 51 and 52 may be used to reveal whether a feature is located on the internal surface or external surface of a pipeline. Thus, the incorporation of the offset magnetic sensor assembly 52 may allow additional information to be collected about pipeline anomalies that may otherwise be unattainable with just the near-wall magnetic sensor assembly 51.

The conductor 400 connects and carries signals from the near-wall magnetic sensor assembly 51 to the sensor process circuit 42. The conductor 410 connects and carries signals from the offset magnetic sensor assembly 52 to the sensor process circuit 42. The process signal produced by the sensor process circuit 42 is sent to the processing and output circuit 44 by the conductor 420. One or more odometers 14 supply signals to an odometer circuit 43 which in turn provides position signals to a signal processing and output circuit 44. The resulting data is then sent to a recorder 45 which records and stores the data.

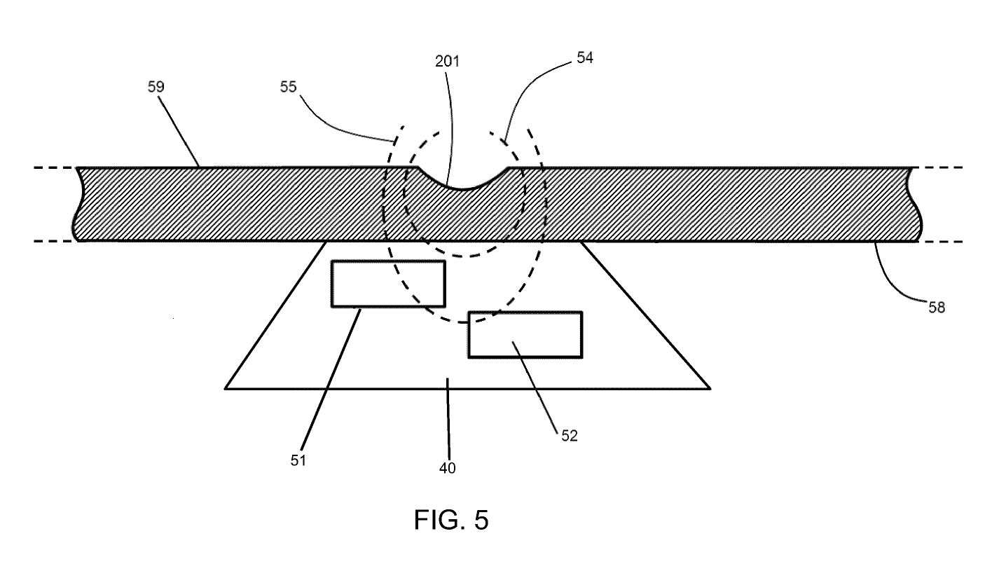

Referring to FIG. 5, an enlarged schematic view of the portion of the instrumentation apparatus 15 depicted in FIG. 4 is shown. An external pipeline feature 201, located on the external pipeline wall 59, responds to the magnetic field generated by the magnets 22A and 22B by causing magnetic flux leakage which may be detected by a plurality of magnetic sensor assemblies 51 and 52. The near-field magnetic flux leakage is detected by the near-wall magnetic sensor assembly 51 as indicated by the inner dotted line 54 and the far-field magnetic flux leakage is detected by the offset magnetic sensor assembly 52 as indicated by the outer dotted line 55. In one embodiment, all of the near-wall and offset magnetic sensor assemblies 51 and 52 are Hall-effect sensors. If only near-wall Hall-effect sensors assemblies 51 were present as is typical in many in-line inspection devices, the data would indicate the existence of a pipeline feature but would be unable to reveal the radial position of the feature, i.e. whether the feature lies on the inner-diameter (ID) or the outer-diameter (OD) of the pipeline wall. It is the addition of the offset Hall-effect sensor assembly 52 which enables additional information to be collected to better interpret the magnetic flux leakage signals. One of the benefits of this additional information is the ability to discriminate between internal and external features without the need for eddy-current sensor systems, as is currently being used for this purpose, which generally consume a greater amount of power than, for example, the Hall effect-type sensor systems 51 and 52.

In another embodiment, particularly in a case in which energy consumption is not a large concern, the magnetic sensors may comprise Hall-effect sensors, eddy current sensors, and other magnetic sensors, or a combination thereof, with an arrangement such as that shown in FIG. 5 wherein one sensor is offset from another.

It should be noted that while FIGS. 4 and 5 show two magnetic sensor assemblies supported by the head assembly 40, various embodiments may include head assemblies which house more than two magnetic sensor assemblies. That is, there may be more magnetic sensor assemblies, however at least one near-wall magnetic sensor assembly 51 and at least one offset magnetic sensor assembly 52 are supported by each head assembly 40.

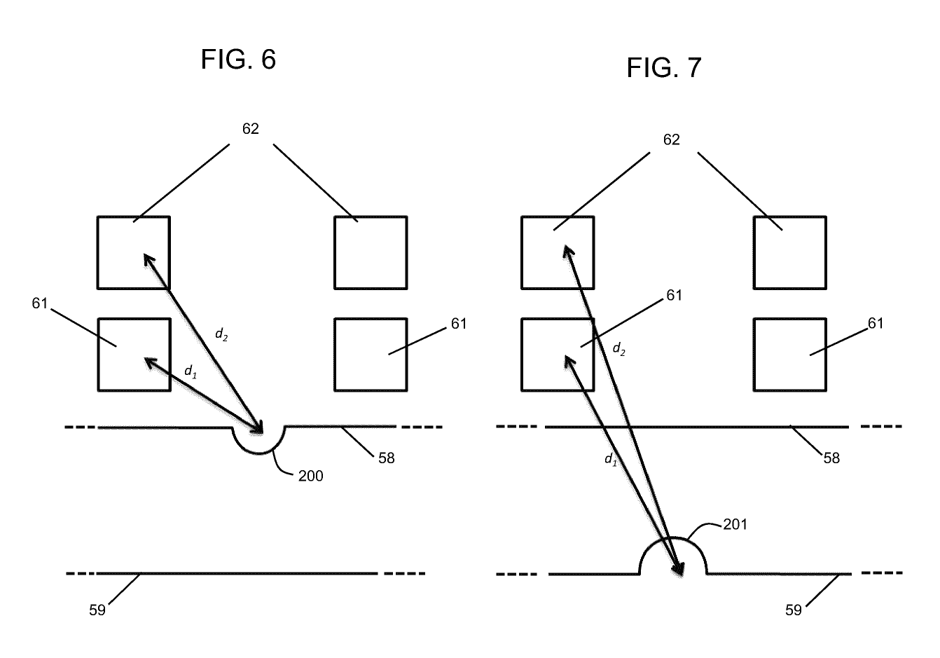

Referring to FIGS. 6 and 7, two schematics illustrate the spatial relationships between a plurality of magnetic sensors 61 and 62, and pipeline features 200 and 201. For simplicity's sake, other components which may be contained alongside the sensors 61 and 62 in magnetic sensor assemblies 51 and 52 are not shown. The distance between a near-wall magnetic sensor 61 and an internal or external pipeline feature 200 or 201 is d₁, and the distance between an offset magnetic sensor 62 and an internal or external pipeline feature 200 or 201 is d₂.

The pipeline wall has thickness t. The magnetic amplitude A₁ at the near-wall magnetic sensor 61 is proportional to:

$${A}_{1} ∝ \frac{1}{{d}_{1}^{3}} ,$$

and the magnetic amplitude A₂ at the offset magnetic sensor 62 is proportional to:

$${A}_{2} ∝ \frac{1}{{d}_{2}^{3}} .$$

The radial position (internal-external position) of the feature can be determined by calculating the ratio of the amplitudes R=A₂/A₁. For an external feature 201, the distances r₁ and r₂ are similar, whereas for an internal feature 200, d₁ is much less than d₂. Thus, the ratio for external features Rₑₓₜ will be somewhat greater than the ratio Rᵢₙₜ for internal features is:

Rₑₓₜ>Rᵢₙₜ

Using some typical dimensions, one can calculate the expected values of R for internal and external features. The following numbers are provided by way of example only and not by limitation. Depending on factors such as the configuration of the in-line inspection device 10, the pipeline size, the dimensions may vary.

t=6.35 mm Pipe wall thickness.
z₁=3 mm Distance of near-wall magnetic sensor 61 above the pipe wall
z₂=6 mm Distance of offset magnetic sensor 62 above the pipe wall
x₁=3 mm Horizontal distance of the feature from near-wall magnetic sensor 61
x₂=3 mm Horizontal distance of the feature from the offset magnetic sensor 62

From these example numbers, the distances d₁ and d₂ for an internal feature 200 and an external feature 201 can be calculated. For the internal feature 200,

d₁=\sqrt{z₁²+x₁²}\sqrt{3²+3²}=4.243 mm,

and

d₂=\sqrt{z₂²+x₂²}=\sqrt{6²+3²}=6.708 mm.

Thus for an internal feature 200, the ratio of the amplitudes recorded by the offset magnetic sensor 62 to the near-wall magnetic sensor 61 is:

$${R}_{int} = \frac{{4.243}^{3}}{{6.708}^{3}} = 0.2530$$

For the external feature 201,

d₁=\sqrt{(z₁+t)²+x₁²}=\sqrt{9.35²+3²}=9.819 mm,

and

d₂=\sqrt{(z₂+t)²+x₂²}=\sqrt{15.35²+3²}=12.709 mm.

Thus for an external feature 201, the ratio of the amplitudes recorded by the offset magnetic sensor 62 to the near-wall magnetic sensor 61 is:

$${R}_{ext} = \frac{{10.170}^{3}}{{15.862}^{3}} = \frac{1051.9}{3990.9} = 0.4612$$

As the example calculation illustrates, the ratio, R, of the amplitude recorded by the offset magnetic sensor 62 to the amplitude recorded by the near-wall magnetic sensor 61 is lower for internal features when compared to the ratio for external features.

This effect is increased if the feature to be analyzed is directly below the sensors such that x₁=0 and x₂=0.

Rₑₓₜ(x=0)=0.434

Rᵢₙₜ(x=0)=0.125

At the sensor location which records the maximum signal from a single feature, if R<0.36, then the feature may be interpreted as being an internal metal-loss feature. If R≥0.36, then the feature is external.

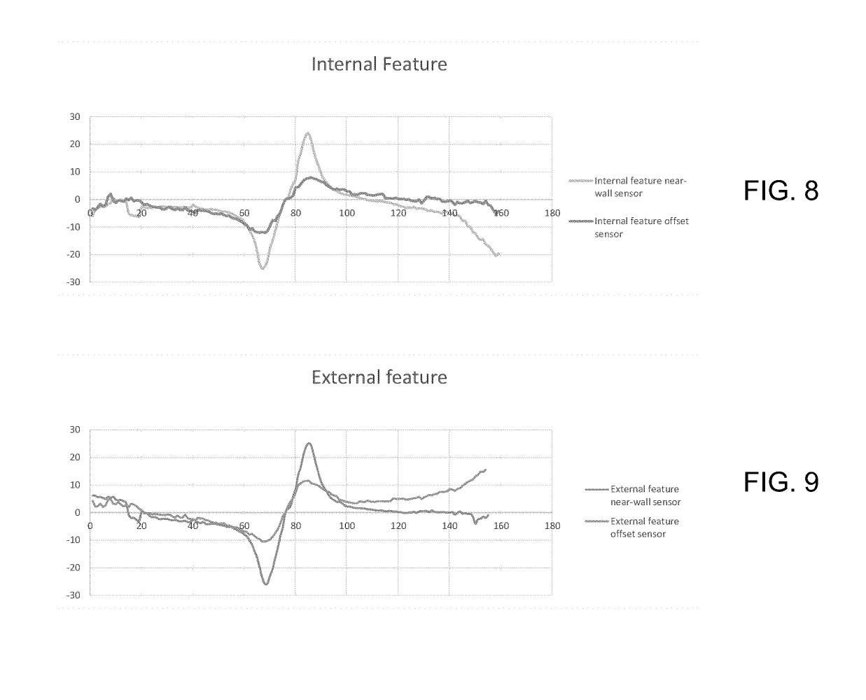

FIGS. 8 and 9 are example graphs which show the magnetic amplitudes obtained by a near-wall sensor 61 and an offset sensor 62 for an internal feature 200 and external feature 201, respectively. Depending on the distance between a feature 200 or 201 and a sensor 61 or 62, and the characteristics of a feature 200 or 201, the magnitude and relative ratios of the magnetic amplitudes may vary. For the example graphs, the values of Rᵢₙₜ and Rₑₓₜ can be calculated to be:

Rᵢₙₜ=0.333

and

Rₑₓₜ=0.4621

As Rᵢₙₜ is less than 0.36 and Rₑₓₜ is greater than 0.36, the values show that the radial position of a feature 200 or 201 can be determined by examining the ratio of the amplitudes recorded by the offset magnetic sensor 62 to the near-wall magnetic sensor 61.

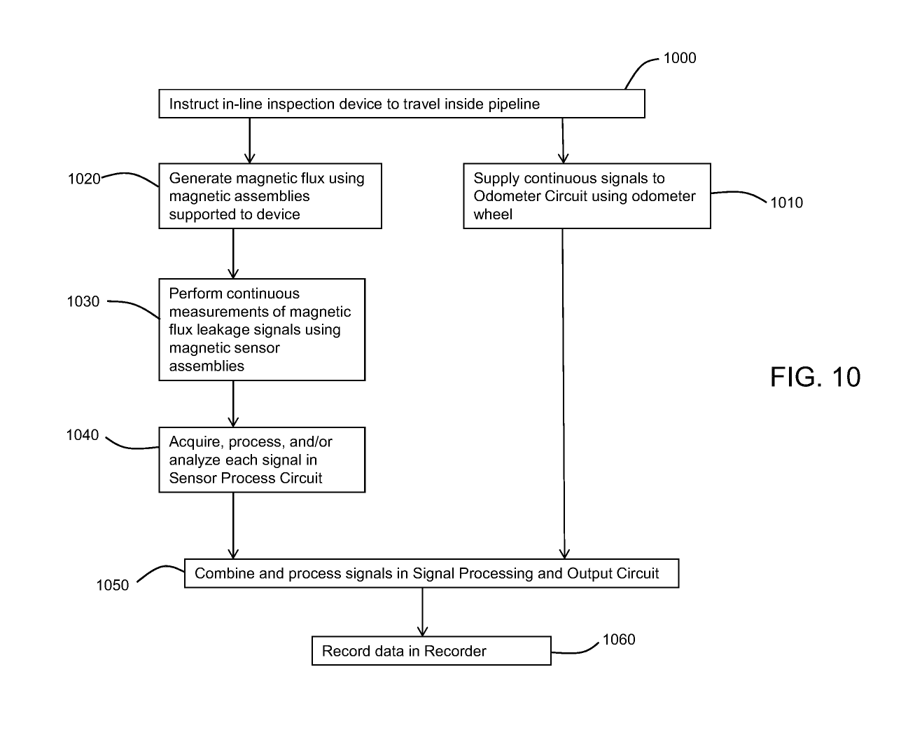

Referring to FIG. 10, an example of a method for generating, acquiring, and processing signals from a plurality of magnetic and position sensor assemblies is illustrated. In step 1000, the in-line inspection device 10 is enabled to travel inside a pipeline by using a fluid pressurize the pipeline and push the device 10 through 41 In step 1010, one or more odometers 14 supply continuous position signals to an odometer circuit 43, which may be used to determine chainage (i.e. the distance from launch). In an alternative embodiment, chainage may instead be determined by an inertial navigation unit, not shown in the figures. In step 1020, a plurality of magnet assemblies 22A and 22B create a magnetic field strong enough to substantially saturate the circumferential length of pipe in between them. In step 1030, the magnetic assemblies 22A and 22B generate signals as they detect magnetic flux leakage caused by pipeline features. According to one embodiment, in step 1040, the individual signals are acquired, processed, and analyzed by the sensor process circuit 42 in order to determine information about a feature, such as its size, and shape, radial position, and clock position. In step 1050, the information from the sensor process circuit 42 and the odometer circuit 43 are combined and processed in the signal processing and output circuit 44. In step 1060, the processed data from step 1050 is recorded by a recorder 45. In an alternative embodiment, step 1040 may involve the sensor process circuit only acquiring and storing the data, leaving the analysis to be performed at a later stage after the pipeline inspection, following step 1060. This analysis stage may be completed by a combination of software and human analysts to detect and characterize a pipeline's features.

While the above examples discuss particular sensor technologies such as Hall effect and Eddy current sensors, it can be appreciated that the principles discussed herein may also be applied to other technologies, such as magneto-diode, magneto-transistor, AMR magnetometer, GMR magnetometer, magnetic tunnel junction magnetometer, magneto-optical sensor, Lorentz force based MEMS sensor, Electron Tunneling based MEMS sensor, MEMS compass, Nuclear precession magnetic field sensor, optically pumped magnetic field sensor, fluxgate magnetometer, search coil magnetic field sensor and SQUID magnetometer, etc.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

For example, it will be appreciated that while certain examples described above are in the context of a “free-swimming” inspection device 10, i.e., that which operates autonomously inside a pipe by being pushed along through the pipe by the fluid inside; the principles discussed herein can also be applied to tethered inspection devices (referred to as “tethered pigs” in the art), which maintain a continuous connection with units outside of the pipe, to control, power, and propel the inspection device.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the inspection device 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. An in-line inspection device to be used in identifying and characterizing features of a metallic pipe structure through which it passes, the in-line inspection device comprising:
a body for travelling inside the pipe structure; and
an instrument apparatus supported by the body, the instrument apparatus comprising a plurality of armatures arranged parallel to each other and positioned circumferentially around the body, a pair of magnetic members of opposing polarities supported at either end of each armature to magnetically saturate a portion of the pipe structure therebetween, and a head assembly positioned between each pair of magnetic members:
a first magnetic sensor assembly to detect signals generated by the magnetic members; and
a second magnetic sensor assembly to detect signals generated by the magnetic members, the second magnetic sensor assembly being offset from the first magnetic sensor assembly to be further from an inner surface of the pipe structure than the first magnetic sensor assembly.

2. The device of claim 1, further comprising:
a plurality of annular cups supported by the body, which center the inspection device and allow the device to be pushed in the direction of fluid flow within the pipe structure.

3. The device of claim 1, further comprising:
at least one odometer to measure the distance travelled by the inspection device.

4. The device of claim 1, further comprising a signal processor for analyzing signals obtained by the magnetic sensor assemblies to determine characteristics about the features of the pipe structure.

5. The device of claim 1, wherein radial positions of the plurality of instrument assemblies are adjustable to conform to variances in the interior pipe dimensions as the device moves through the pipe structure.

6. The device of claim 1, wherein the magnetic sensor assemblies contain Hall-effect sensors.

7. The device of claim 1, further comprising at least one additional magnetic assemblies.

8. The device of claim 1, wherein the device is propelled by either fluid in the pipe structure, or by a tethered system.

9. A method of identifying and characterizing features of a metallic pipe structure comprising:
introducing an in-line inspection device into the pipe structure;
having the in-line inspection device travel within the pipe structure;
generating, by a plurality of magnetic assemblies, a magnetic field to magnetically saturate a portion of the pipe through which the in-line inspection device is passing;
detecting and collecting, by a plurality of near-wall and offset magnetic sensor assemblies, magnetic flux leakage signals;
providing the magnetic flux leakage signals to a signal processor; and
using the signal processor to process the provided signals.

10. The method of claim 8, further comprising providing processed data to a data recorder.

11. The method of claim 8, further comprising generating, by at least one odometer, position signals and providing the positions signals to an odometer circuit.

12. The method of claim 8, wherein the magnetic flux leakage signals are processed to determine at least one characteristic of the pipe structure that can discriminate between inner diameter and outer diameter defects.

13. The method of claim 9, wherein the inspection device is propelled by either fluid in the pipe structure, or by a tethered system.
